(19) United States
(12) Patent Application Publication
(10) Pub. No.: US 2017/0144441 A1
(43) Pub. Date: May 25, 2017

(54) OVERSIZED PRINTER HEAD AND PRINTER USING SAME

(71) Applicants: HON HAI PRECISION INDUSTRY CO., LTD., New Taipei (TW); Fu Tai Hua Industry (Shenzhen) Co., Ltd., Shenzhen (CN)

(72) Inventor: Xue-Qin ZHANG, Shenzhen (CN)

(21) Appl. No.: 14/956,915

(22) Filed: Dec. 2, 2015

(30) Foreign Application Priority Data
Nov. 19, 2015 (CN) 201510797879.1

(51) Int. Cl. B41J 2/14

(52) U.S. Cl. CPC B41J 2/14201

(57) ABSTRACT

An oversized inkjet printer head includes: an ink applying unit having a plurality of ink supply channels and a plurality of ink nozzle holes formed into an array, with each of the plurality of ink supply channels connected to one of the plurality of ink nozzle holes; and a driving unit configured to expel the ink supplied through the ink supply channels through the ink nozzle holes. The driving unit selectively supplies ink to at least a portion of the plurality of ink supply channels when the printer head is activated to print text or imagery on a printable surface. The printer head is stationary relative to the printable surface when the printer head is activated to print on the printable surface. The dimension of the array of ink nozzle holes is substantially the same as the dimension of the printable surface.

This application claims priority to Chinese Patent Application No. 201510797879.1 filed on Nov. 19, 2015, the contents of which are incorporated by reference herein.

### FIELD

The subject matter herein generally relates to a printer head and a printer having the printer head, and particularly to a printer head whose size is substantially the same as the size of a printable surface to be printed by the inject printer and an inkjet printer having the printer head.

### BACKGROUND

Present printers can be basically classified into two types: laser printers and inkjet printers. A laser printer produces text and graphics by passing a laser beam over an electron-charged, cylindrical drum, to define a charged image. The drum then collects electrically-charged, powdered ink, and transfers the image to a printable surface which is then heated in order to permanently fuse the text/imagery.

An inkjet printer has a printer head which can directly propel droplets of ink onto a printable surface to form text/imagery thereon. The printer head reciprocates along a rail to print the text/imagery on the printable surface which is moved perpendicularly to the movement of the printer head.

In general, the inkjet printer has a structure and cost which are simpler and lower than the laser printer. Nevertheless, the inkjet printer has a printing speed which is slower than the laser printer.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a perspective view of an inkjet printer having a printer head in accordance with the present disclosure.

FIG. 2 is a perspective view of the printer head of the inkjet printer in accordance with an exemplary embodiment of the present disclosure.

FIG. 3 is a partial perspective view of the printer head of FIG. 2 in accordance with a first embodiment of the present disclosure.

FIGS. 4-6 are cross-sectional views illustrating the working principle of the printer head of FIG. 3.

FIG. 7 is a partial perspective view of the printer head of FIG. 2 in accordance with a second embodiment of the present disclosure.

FIGS. 8-11 are cross-sectional views illustrating the working principle of the printer head of FIG. 7.

FIG. 12 is a block diagram illustrating the printer head in accordance with the present disclosure in connection with a computer device.

FIGS. 13-14 are perspective views respectively showing a printer head and four printer head parts for forming the printer head of FIG. 13.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape or other word that substantially modifies, such that the component need not be exact. For example, substantially rectangular means that the object resembles a rectangle, but can have one or more deviations from a true rectangle. The term “module” refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like.

The present disclosure is described in relation to an inkjet printer, and in particular to an inkjet printer which has a printer head having a estate area substantially the same as a printable surface that the inkjet printer is intended to print whereby the printing can be completed almost instantly and noiselessly.

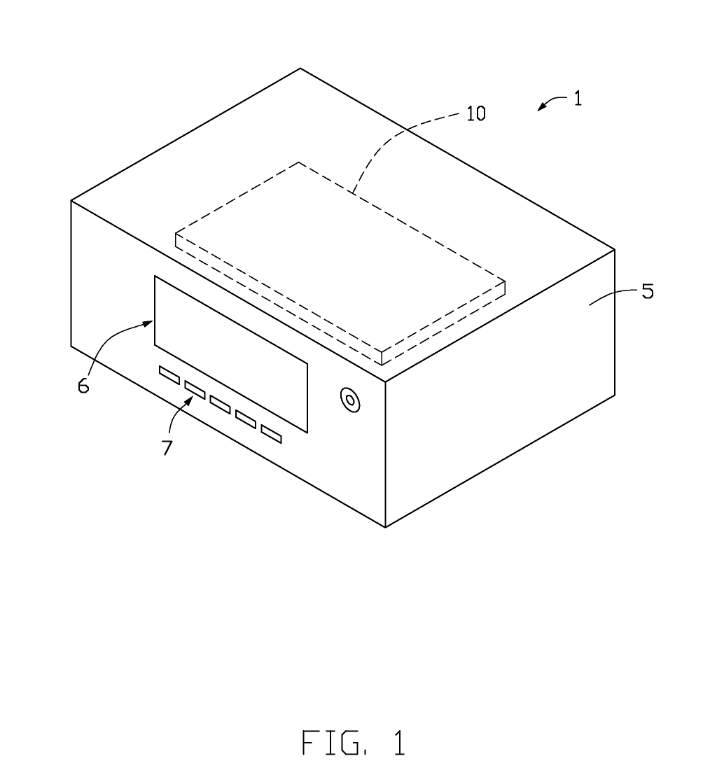

FIG. 1 illustrates an inkjet printer 1 having a casing 5 and a printer head 10 received in the casing 5 for performing printing to printable surfaces (not shown) received in the casing 5. The inkjet printer 1 further has a transporting mechanism (not shown) for moving a printable surface, for example, a sheet of paper to be located under to the printer head 10 to be printed by the printer head 10. The inkjet printer 1 has a display monitor 6 and operation buttons 7 on a front side of the casing 5 for facilitating a user to operate the inkjet printer 1.

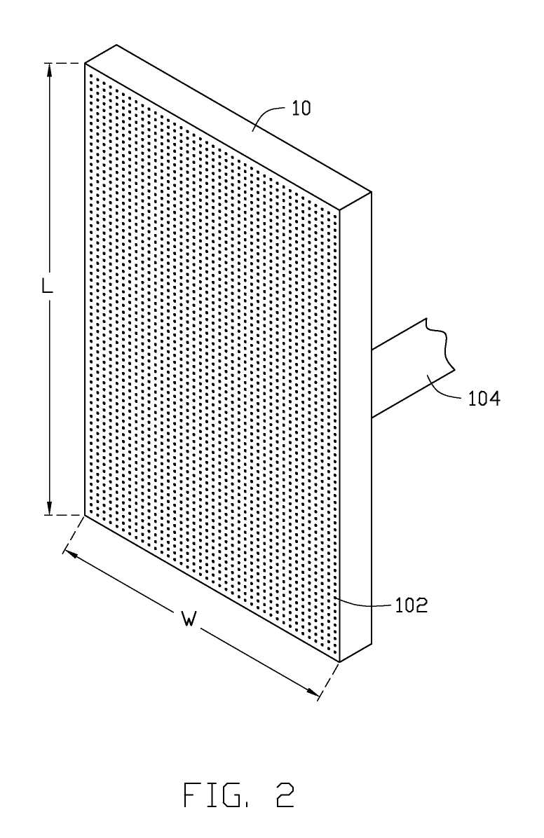

FIG. 2 illustrates the printer head 10 of the inkjet printer 1 in accordance with the present disclosure in more detail. The printer head 10 has an estate area that is substantially rectangular and has a dimension substantially the same as that of a printable surface that the inkjet printer 1 is intend to print, which in accordance with the preferred embodiment is A4 paper whose dimension is 210 mm*297 mm. Accordingly, the estate area of the printer head 10 has a width W about 210 mm, and a length about 297 mm. A plurality of nozzle holes 102 is defined in a bottom surface of the printer head 10 and forms an array, while an electrical connector 104 is formed on a top surface thereof for electrically coupling with a power source of the inkjet printer 1. Through the nozzle holes 102, ink in the printer head 10 can be propelled onto the printable surface to print text/imagery thereon. In at least one embodiment, the estate area of the printer head 10 can be defined by the array of the nozzle holes.

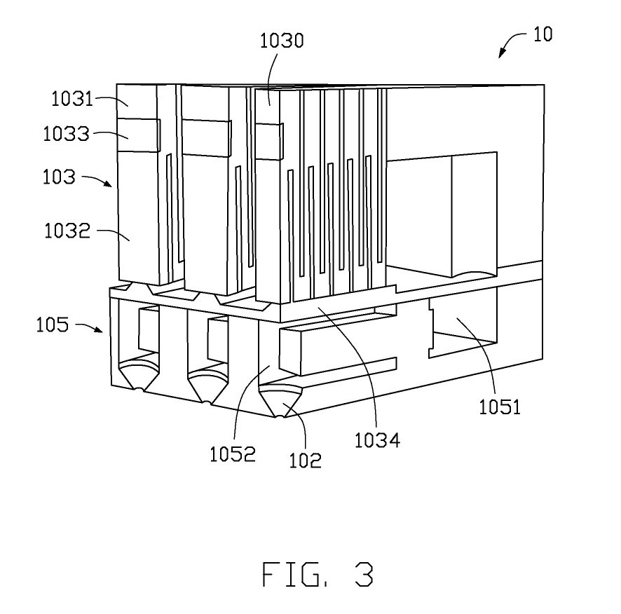

As shown in FIG. 3, the printer head 10 in accordance with a first embodiment of the present disclosure includes a piezoelectric driving unit 103 and an ink applying unit 105 located below the piezoelectric driving unit 103. The piezoelectric driving unit 103 includes a plurality of piezoelectric elements 1030 each corresponding to a nozzle hole 102. Each piezoelectric element 1030 includes an upper electrode 1031, a lower electrode 1032, a piezoelectric material 1033 between the upper and lower electrodes 1031, 1032, and a vibrator 1034 secured to a bottom of the lower electrode 1032. The vibrator 1034 is made of a metal plate. The upper electrode 1031 is configured to electrically couple with a negative terminal of the power source, while the lower electrode 1032 is configured to electrically couple with a positive terminal thereof. The ink applying unit 105, in addition to the nozzle holes 102, further defines an ink reservoir 1051 and a plurality of ink channels 1052 in fluidic communication with the ink reservoir 1051 and the nozzle holes 102. Each of the plurality of ink supply channels is connected to, and capable of selectively supplying ink through, one of the plurality of ink nozzle holes.

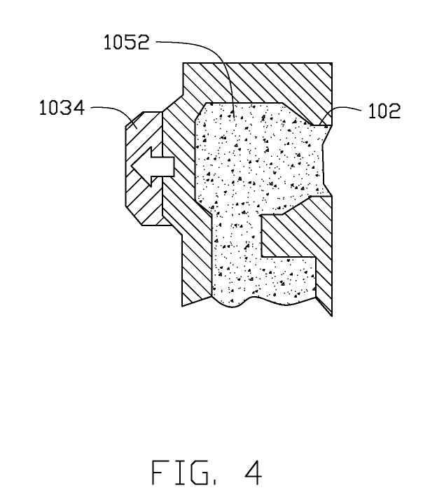

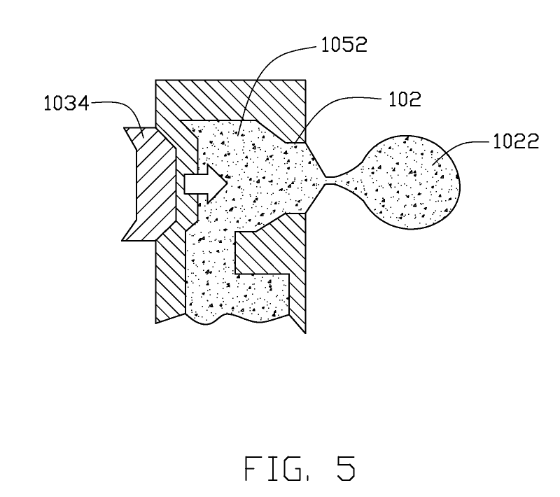

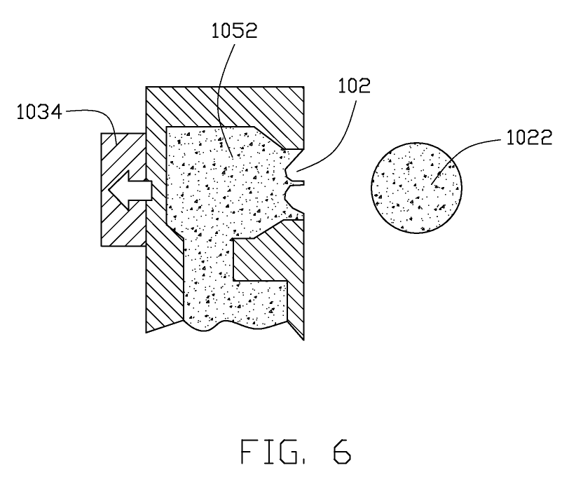

Referring to FIGS. 4-6, and first to FIG. 4, when a power is applied to the piezoelectric element 1030 to make the piezoelectric material 1033 contract, the vibrator 1034 applies a pull force to ink in the ink channel 1052 and the corresponding nozzle hole 102 to draw the ink away from the nozzle hole 102. Accordingly, no ink is permitted to flow out through the corresponding nozzle hole 102 to perform the printing activity. The pull force can decide the size of an ink droplet to be propelled out of the corresponding nozzle hole 102. Referring to FIG. 5, then when the power applied to the piezoelectric element 1030 is stopped to make the piezoelectric material 1033 expand, the vibrator 1034 applies a push force to the ink in the ink channel 1052 and the corresponding nozzle hole 102 to force an ink droplet 1022 with predetermined size, which flows outwardly through the corresponding nozzle hole 102 thereby to perform the required printing activity. The size of the ink droplet 1022 pushed out of the ink channel 1052 and the nozzle hole 102 by the vibrator 1034 can be controlled by the voltage of the power applied to the piezoelectric material 1033 through the upper and lower electrodes 1031, 1032. Referring to FIG. 6, after the required ink droplet 1022 leaves the nozzle hole 102 to be applied to the printable surface, the vibrator 1034 returns to its natural position to apply a pull force to the ink to keep the ink in the ink channel 1052 and the nozzle hole 102. At the natural position of the vibrator 1034, still no power is applied to the piezoelectric element 1030.

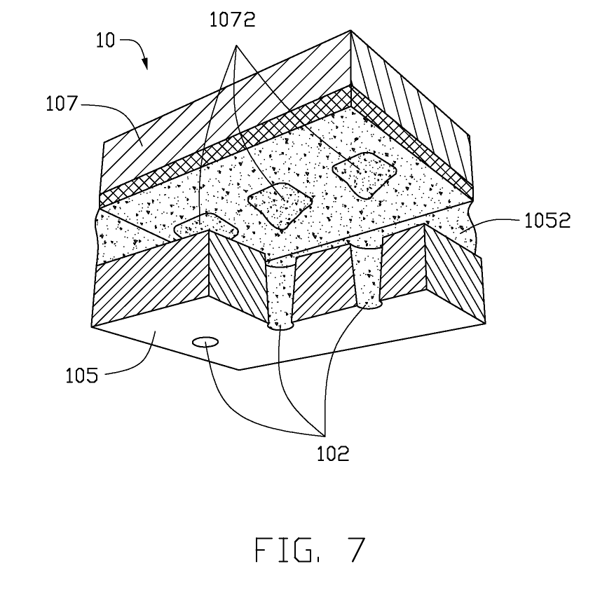

FIG. 7 shows the printer head 10 in accordance with another embodiment of the present disclosure. In the second embodiment, the printer head 10 has a heating driving unit 107 and an ink applying unit 105. The heating driving unit 107 includes a plurality of heating resistors 1072 each located in alignment with a corresponding nozzle hole 102. The ink applying unit 105 includes an ink reservoir (not shown) and a plurality of ink channels 1052 in fluidic communication with the ink reservoir and the nozzle holes 102. Each of the plurality of ink supply channels is connected to, and capable of selectively supplying ink through, one of the plurality of ink nozzle holes.

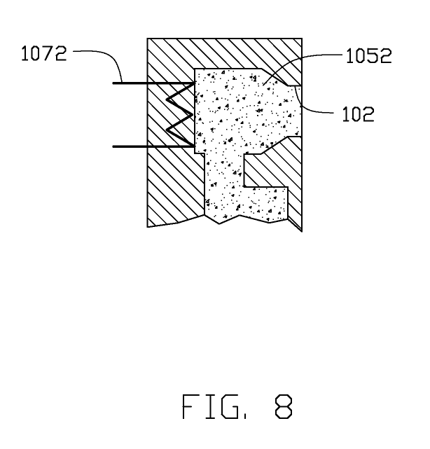

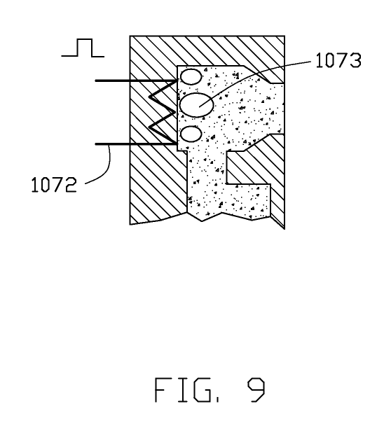

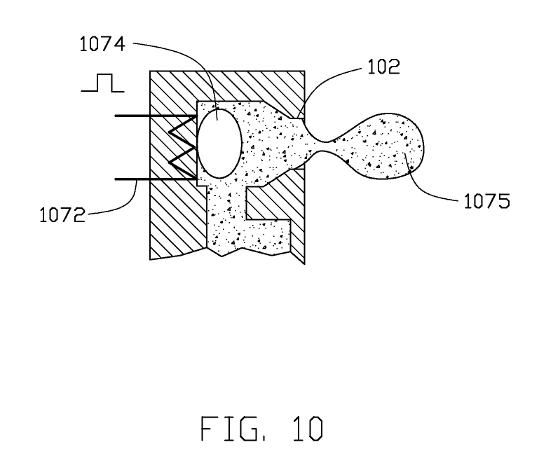

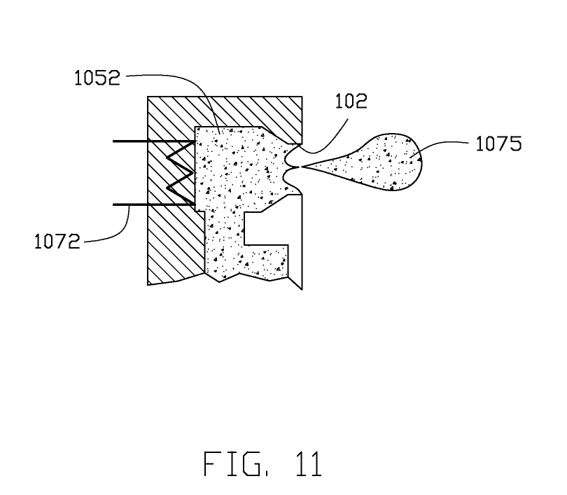

Referring to FIGS. 8-11, and first to FIG. 8, when no power is applied to the heating resistor 1072, the ink fills in the ink channel 1052 and the nozzle hole 102. Then referring to FIG. 9, the heating resistor 1072 is supplied with power to generate heat which heats the ink to generate small bubbles 1073 therein. In FIG. 10, the heating is continued until the small bubbles 1073 merge together to generate a large bubble 1074 which pushes a portion of the ink in front thereof out of the nozzle hole 102 to form an ink droplet 1075 with a predetermined size. In FIG. 11, the bubble 1074 bursts to force the ink droplet 1075 to leave the nozzle hole 102 to perform the printing activity. The size of the ink droplet 1075 pushed out of the ink channel 1052 and the nozzle hole 102 by the bubble 1074 can be controlled by the ampere or the period of time of the power applied to the heating resistor 1072. The heating of the ink by the heating resistor 1072 is then stopped.

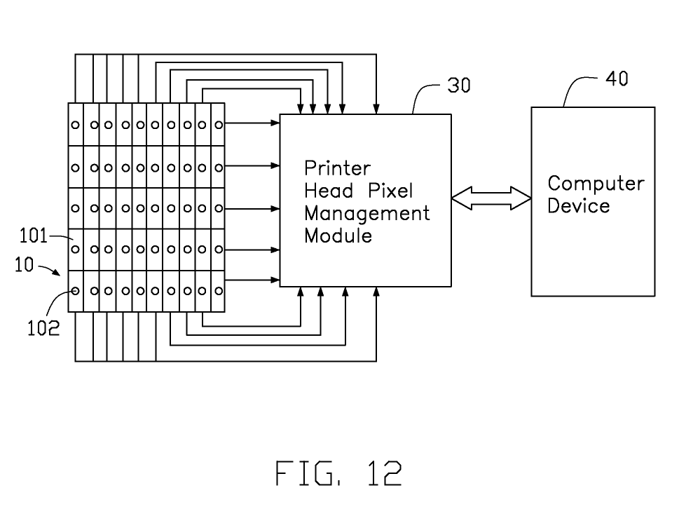

Referring to FIG. 12, the printer head 10 consists of a plurality of nozzles 101 each defining a corresponding nozzle hole 102. The nozzles 101 are electrically coupled to a printer head pixel management module 30 (hereafter management module 30) also via the electrical connector 104 (FIG. 2), which controls actuation of each of the nozzles 101 to control opening or closing of each of the nozzle holes 102. Each nozzle hole 102 represents a pixel. The management module 30 is in bi-directional data communication with a computer device 40 whereby data can be transferred from the computer device 40 to the management module 30 and vice versa. The computer device 40 can be, but not limited to, a desktop computer, a laptop computer, a tablet computer and a smart phone. The bi-directional data communication can be achieved by wired or wireless connection between the inkjet printer 1 and the computer device 40.

In performing the printing work, the management module 30 receives a file to be printed from the computer device 40, which can be, but not limited to, a WORD file, an EXCEL file, a PNG (Portable Network Graphics) file or a JPEG (Joint Photographic Experts Group) file. A printable surface, for example, a sheet of paper, is fed to a position under the bottom face of the printer head 10 defining the nozzle holes 102. Thereafter, the management module 30 controls the actions of the nozzles 101 and the piezoelectric elements 1030 or the heating resistors 1072 to propel required ink droplets out of the nozzle holes 102 and onto the printable surface to print out the file thereon. Since there is no movement of the printer head 10 relative to the printable surface during the printing, a relatively low level of noise will be generated during the printing process. Furthermore, since the printer head 10 prints out the text/imagery of the file throughout the printable surface simultaneously, the printing speed can be greatly enhanced. For example, when printing an A4 sheet of paper by the conventional inkjet printer which has a printer head with a dimension of 2*2 cm and supposed that the printing resolution is 300 dpi (dot per inch), the printer head needs to move 156 times to compete the printing. Since the printer head 10 in accordance with the present disclosure does not need to move to complete the printing, the inkjet printer 1 having the printer head 10 in accordance with the present disclosure can be 156 times faster than the conventional inkjet printer.

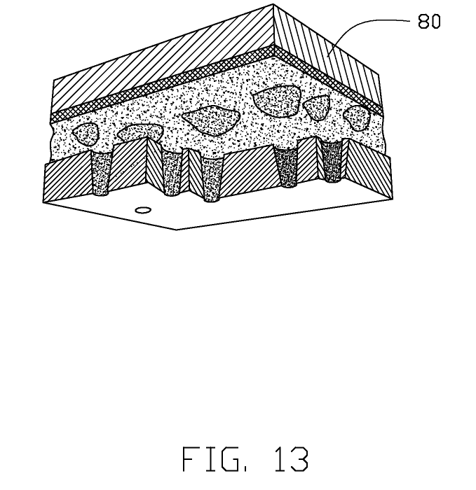

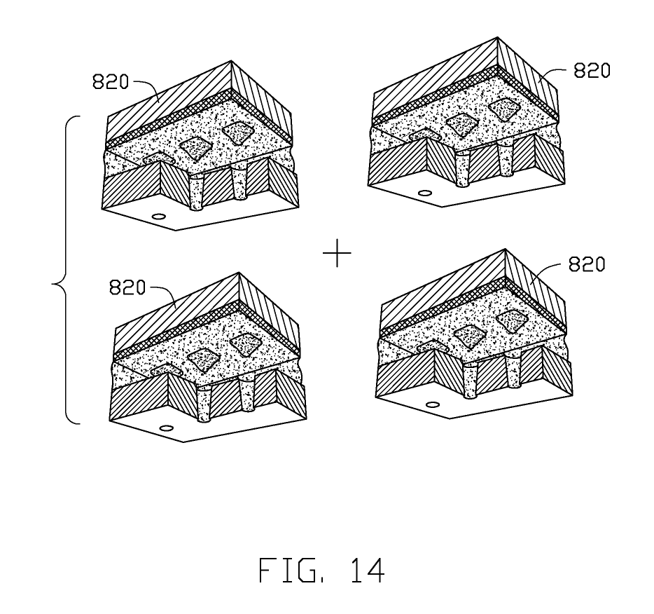

In accordance with the present disclosure, the printer head can be consisted of a plurality of separable parts such as the printer head 80 of FIG. 13 is formed by coupling printer head parts 820 of FIG. 14 together. For example, when the estate area or the array of the nozzle holes 120 of the printer head 80 has a dimension of A4 paper, the estate area or the array of the nozzle holes 120 of each printer head part 820 can have a dimension of substantially A8 paper. The A8 paper has a width about 52 mm and a length about 74 mm. By such design, maintenance or repair of the printer head 80 can be more easily achieved. Furthermore, the printer head can be expanded to the required dimension when necessary. For example, a printer head having an estate area that has a dimension of A3 paper can be formed by connecting two printer heads each having an estate area that has a dimension of A4 paper. Known means such as tenons and mortises (not shown) can be formed on sides of the printer head parts 820 to facilitate the assembly.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in particular the matters of shape, size and arrangement of parts within the principles of the present disclosure, up to and including the full extent established by the broad general meaning of the terms used in the claims.

1. An oversized inkjet printer head comprising:
an ink applying unit having a plurality of ink supply channels and a plurality of ink nozzle holes formed into an array, with each of the plurality of ink supply channels connected to, and capable of selectively supplying ink through, one of the plurality of ink nozzle holes; and
a driving unit configured to selectively supply ink to at least a portion of the plurality of ink supply channels and to expel the ink supplied through the supplied ink supply channels through the ink nozzle holes connected to the supplied ink supply channels;
wherein, the driving unit selectively supplies ink to at least a portion of the plurality of ink supply channels when the oversized inkjet printer head is activated to print text or imagery on a printable surface;
wherein, the driving unit comprises a plurality of heating resistors each corresponding to one of the nozzle holes, each heating resistor heating ink in a corresponding ink supply channel and nozzle hole to generate a bubble therein, and the bubble bursts to force the ink in the corresponding ink channel and nozzle hole to flow out of the corresponding nozzle hole;
wherein, the oversized inkjet printer head is stationary relative to the printable surface when the oversized inkjet printer head is activated to print on the printable surface; and
wherein, the dimensions of the array of ink nozzle holes is substantially the same as the dimensions of the printable surface
wherein the ink applying unit further comprises an ink reservoir, the ink channels interconnecting the ink reservoir and the nozzle holes;
wherein the printer head further comprises a printer head pixel management module, wherein each of the nozzle holes is defined by a nozzle which is electrically coupled with the printer head pixel management module for controlling opening and closing of each nozzle hole.

2-3. (canceled)

4. The printer head of claim 3, wherein the printer head pixel management module is configured for receiving a file from a computer device to be printed by the printer head.

5. The printer head of claim 4, wherein the driving unit includes a plurality of piezoelectric elements each corresponding to one of the nozzle holes, each piezoelectric element comprising an upper electrode, a lower electrode, a piezoelectric material between the upper electrode and the lower electrode, and a vibrator attached to a bottom of the lower electrode and facing the one of the nozzle holes, the vibrator being controlled by an action of the piezoelectric material to push ink in a corresponding ink channel and nozzle hole out of the corresponding nozzle hole or to pull the ink to keep it in the corresponding ink channel and nozzle hole.

6. The printer head of claim 5, wherein a size of a droplet of the ink pushed out of the corresponding nozzle hole by the vibrator is determined by voltage of electricity supplied to the upper and lower electrodes.

7. The printer head of claim 6, wherein when the piezoelectric material is in either one of contracted condition and natural condition, the vibrator pulls the ink to keep it in the corresponding ink channel and nozzle hole, and when the piezoelectric material is expanded, the vibrator pushes the ink out of the corresponding nozzle hole.

8. The printer head of claim 7, wherein the printer head is formed by combining a plurality of separable printer head parts together.

9-11. (canceled)

12. The printer head of claim 4, wherein the printable surface is A4 paper which is about 210 mm in width and about 297 mm in length, and the array of ink nozzle holes has a dimensions of A4 paper.

13. The printer head of claim 4, wherein the printer head is formed by combining a plurality of separable printer head parts together.

14. The printer head of claim 13, wherein the array of ink nozzle holes of the printer head has a dimension substantially the same as A4 paper and the array of ink nozzle holes of each printer head part has a dimension substantially the same as A8 paper, and wherein the A4 paper has a width about 210 mm and a length about 297 mm, while the A8 paper has a width about 52 mm and a length about 74 mm.

15-20 (canceled)
